(19) United States
(12) Patent Application Publication
(10) Pub. No.: US 2026/0124652 A1
(43) Pub. Date: May 7, 2026

(54) MODULAR ORGANIC SUBSTANCE PROCESSING SYSTEM

(71) Applicant: JAPJAP Zero Waste Limited, Wan Chai (HK)

(72) Inventor: Man Wai Chan, Wan Chai (HK)

(21) Appl. No.: 18/995,308

(22) PCT Filed: Nov. 20, 2024
(86) PCT No.: PCT/CN2024/133314

§ 371 Date: Jan. 16, 2025

(30) Foreign Application Priority Data
Nov. 23, 2023 (HK) 22023083096.4

(51) Int. Cl. B09B 3/60; B09B 3/35; B09B 101/70; C05F 9/02; C05F 17/05; C05F 17/70

(52) U.S. Cl. CPC B09B 3/60; B09B 3/35; C05F 9/02; C05F 17/05; C05F 17/70; B09B 2101/70

(57) ABSTRACT

A modular organic substance processing system comprising:—a modular frame arranged to support a plurality of containers, each container housing a plurality of decomposition organisms arranged to aid in the decomposition of organic substance, wherein the modular frame includes a plurality of shelf members, each shelf member being arranged to be stackable on another shelf member to define the modular frame and further comprises a shredder unit arranged to shred the organic substance and to deposit the shredded organic substance into one of the plurality of containers.

### TECHNICAL FIELD

The present invention relates to a modular organic substance processing system, and particularly, although not exclusively, to a modular food waste processing system using decomposition organisms such as insects.

### BACKGROUND

In modern urban lifestyles, the problem of waste disposal and recycling is a commonly known issue. However, solutions that have been devised are often unsuitable for high density urban lifestyles where additional private spaces may have to be arranged for waste processing. The result of this is that many persons living in high density areas such as urban areas are unable or less inclined to commit to waste processing since urban space is a valuable commodity.

In turn, the lack of commitment from everyday people to process their waste can lead to significant environmental impact. One such significant impact is the usage of landfill to store food waste, which uses up significant resources of valuable land. Moreover, when food waste is dumped into landfill, the original cycle of carbon recycling and return of nutrients to the soil in which organic matter requires to grow is lost, resulting in a continued imbalance between everyday living and the natural environment.

This continuation in the imbalance places further strain on environmental issues, including soil erosion, environmental pollution, environmental damage from mining and the uncontrolled releases of greenhouse gases.

### SUMMARY OF THE INVENTION

In accordance with a first aspect of the present invention, there is provided a modular organic substance processing system comprising:
a modular frame arranged to support a plurality of containers, each container housing a plurality of decomposition organisms arranged to aid in the decomposition of organic substance, wherein the modular frame includes a plurality of shelf members, each shelf member being arranged to be stackable on another shelf member to define the modular frame.

In an embodiment of the first aspect, the system further comprises a shredder unit arranged to shred the organic substance and to deposit the shredded organic substance into one of the plurality of containers.

In an embodiment of the first aspect, the modular frame includes a separation column to separate the plurality of shelf members into an upper portion and a lower portion, each portion arranged to house a plurality of containers.

In an embodiment of the first aspect, the separation column creates a gap for the shredder unit to be disposed therein.

In an embodiment of the first aspect, the organic substance includes food waste items.

In an embodiment of the first aspect, the decomposition organisms include insects.

In an embodiment of the first aspect, the insects are Black Soldier fly larvae.

In an embodiment of the first aspect, the containers include one or more environmental sensors arranged to detect the environment data representative of the conditions of each of the containers, and the one or more environmental sensors are arranged to communicate with a communication gateway to transmit the environmental data to one or more users.

In an embodiment of the first aspect, the environmental sensors include a temperature sensor, humidity sensor, weight sensor, chemical sensor, or any one or combination thereof.

In an embodiment of the first aspect, the plurality of shelf members are reused pallet members.

In an embodiment of the first aspect, wherein the container includes a mixer module arranged to manipulate the plurality of decomposition organisms and the organic substance.

In an embodiment of the first aspect, the mixer module includes one or more manipulation arms arranged to be driven by a motor unit to manipulate the plurality of decomposition organisms and the organic substance.

In an embodiment of the first aspect, the one or more manipulation arms are arranged to extend away from a central rotational axis, the axis being driven by a motor to move the one or more manipulation arms within a container body containing the decomposition organisms and the organic substance.

In an embodiment of the first aspect, the one or more manipulation arms are moved slowly within the container body.

In an embodiment of the first aspect, the container is further arranged to receive dry organic material or water to adjust the humidity of the decomposition organisms and the organic substance.

In an embodiment of the first aspect, the one or more manipulation arms are moved with varying speed to adjust the humidity of the decomposition organisms and the organic substance.

In accordance with a second aspect of the invention, there is provided an enhanced container for a modular organic substance processing system comprising:
a container body arranged to receive a mixture of decomposition organisms and organic substance;
a mixer module arranged to manipulate the mixture of decomposition organism and organic substance; and,
a controller unit arranged to automatically control the mixer module to adjust the manipulation of the mixture of decomposition organism and organic substance.

In an embodiment of the second aspect, the system further comprises:
a sensor module arranged to measure the humidity and temperature of the mixture of decomposition organisms and organic substance.

In an embodiment of the second aspect, the humidity and temperature of the mixture of decomposition organisms and organic substances triggers a humidity or temperature adjustment response, which includes: the addition of dry organic substance or water to adjust the humidity of the mixture; or the application of heat or air flow to adjust the temperature of the mixture; and the speed of the manipulation of the mixture of decomposition organism and organic substance.

In an embodiment of the second aspect, the container includes an access door with a vent aperture, wherein the vent aperture is arranged to access the contents of the container body and the access door is arranged to access the container body, mixer module, the controller unit and the sensor module.

In accordance with a third aspect, there is provided a food processing component for use as part of a food production chain comprising: a modular frame arranged to support a plurality of containers, each container housing a plurality of decomposition organisms arranged to aid in the decomposition of organic substance, wherein the modular frame includes a plurality of shelf members, each shelf member being arranged to be stackable on another shelf member to define the modular frame. In an embodiment of the third aspect, the plurality of containers includes one or more enhanced containers for a modular organic substance processing system comprising:
a container body arranged to receive a mixture of decomposition organisms and organic substance;
a mixer module arranged to manipulate the mixture of decomposition organism and organic substance;
a controller unit arranged to automatically control the mixer module to adjust the manipulation of the mixture of decomposition organism and organic substance; and,
   Wherein the one or more enhanced containers are supported by adapting the size of the shelf members.

In an embodiment of the third aspect, the food processing component further comprises:
a sensor module arranged to measure the humidity and temperature of the mixture of decomposition organisms and organic substance, and;
   wherein the sensor module is further arranged to include a chemical sensor arranged to measure the ammonia content of the mixture of decomposition organisms and organic substance.

In an embodiment of the third aspect, the humidity and temperature of the mixture of decomposition organisms and organic substances triggers a humidity or temperature adjustment response, which includes: the addition of dry organic substance or water to adjust the humidity of the mixture; or the application of heat or air flow to adjust the temperature of the mixture; and the speed of the manipulation of the mixture of decomposition organism and organic substance.

In an embodiment of the third aspect, the container includes an access door with a vent aperture, wherein the vent aperture is arranged to access the contents of the container body and the access door is arranged to access the container body, mixer module, the controller unit and the sensor module.

### BRIEF DESCRIPTION OF THE DRAWINGS

Embodiments of the present invention will now be described, by way of example, with reference to the accompanying drawings in which:

FIG. 1 is a diagram showing an example modular organic substance processing system in accordance with one embodiment of the present invention;

FIG. 2 is a flow diagram illustration of an example of the process performed by the system of FIG. 1 in processing food waste;

FIG. 3 are drawings of various pallet members arranged to be used to define the modular frame of the system of FIG. 1;

FIG. 4 are drawings of the assembly of various pallet members of FIG. 3 into a modular frame of the system of FIG. 1; and,

FIG. 5 is a block diagram illustrating the use of sensors and other Internet of Things (IoT) devices in the system of FIG. 1.

FIG. 6A is a photograph of an example embodiment of a smart or enhanced container for use with the system of FIG. 1;

FIG. 6B is a photograph of an example embodiment of a smart or enhanced container for use with the system of FIG. 1 with its door opened;

FIG. 6C is another photograph of an example embodiment of a smart or enhanced container for use with the system of FIG. 1;

FIG. 6D is a photograph of an example embodiment of a container body and manipulation arms of the smart or enhanced container of FIG. 6A;

FIG. 7A is a perspective exploded diagram of the smart or enhanced container of FIG. 6A;

FIG. 7B is a side exploded diagram of the smart or enhanced container of FIG. 6A; and,

FIG. 7C is an exploded diagram of the container body and motor unit of the smart or enhanced container of FIG. 6A.

### DETAILED DESCRIPTION OF THE PREFERRED EMBODIMENT

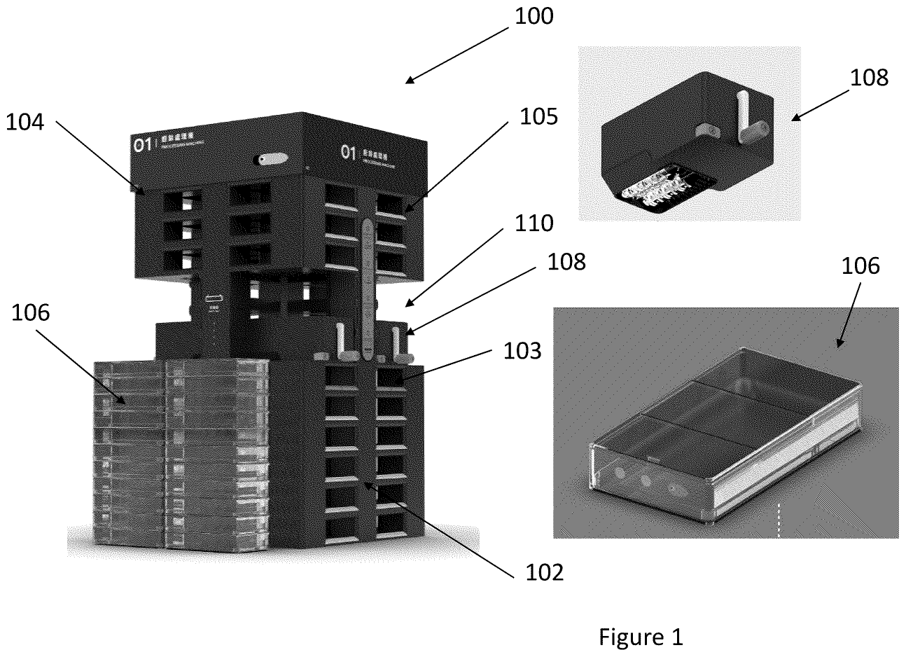

Referring to FIG. 1, there is illustrated an example embodiment of a modular organic substance processing system 100 comprising: a modular frame arranged to support a plurality of containers 106, each container 106 arranged to house a collection of decomposition organisms arranged to aid in the decomposition of the organic substance, wherein the modular frame 103 includes a plurality of shelf members 105, each shelf members 105 arranged to be stackable on another shelf member 105 to define the modular frame 103.

Preferably, the system 100 further comprises a shredder unit 108 arranged to shred the organic substance and to deposit the shredded organic substance into one of the plurality of containers 106; and wherein the containers 106 include one or more environmental sensors or camera units arranged to detect or capture the environment data representative of the conditions of each of the containers 106, and the environmental sensors are arranged to communicate with a communication gateway to transmit the environmental data to one or more users.

In this embodiment as shown in FIG. 1, the modular organic substance processing system 100 is arranged to include a plurality of containers 106 which are arranged to store various organic substances that are to be or are being processed. These organic substances may include food scraps or food waste items or other similar organic substances that may be generated from the manufacturing, processing or leftovers from the consumption of food or other organic items.

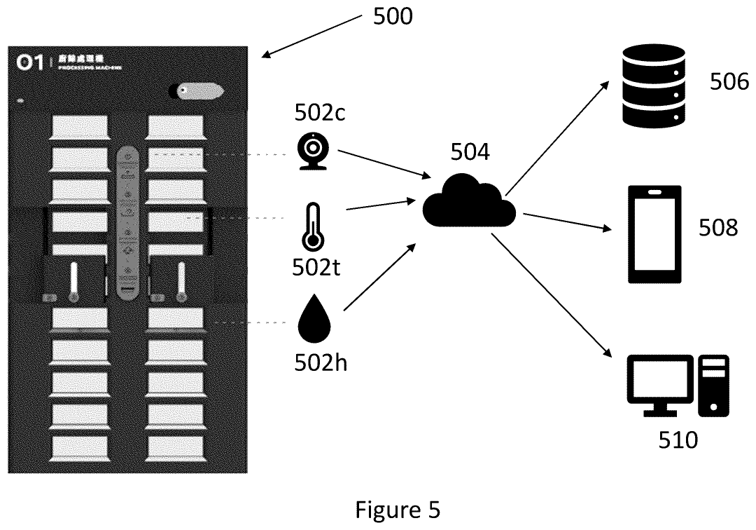

In this example embodiment, the containers 106 may also be in the form of a planar tray with an opening for access into the main container body, although other types of containers are possible. The containers 106 may have a removable cover, which may be removed by a user or it may be integrated with the containers 106 and be arranged to be folded away or slide away from the container body so as to allow access to the container. In some examples, as it will be explained below with reference to FIG. 5, where electronic control or automated control of the condition of the system is implemented, the containers 106 may also have an electronic control door, or spring-loaded cover with a mechanism in which the cover may be opened or closed by a mechanical member controlled by a computer. This is particularly advantageous in implementations whereby the environmental conditions of the container require automated intervention, such as the addition of moisture, cooling by fan or the addition of additional food waste, and thus in order to perform these intervention tasks, the cover of the container 106 may be movable by a mechanical, electromechanical or robotic means such that the contents of the container 106 may be manipulated.

Within the container 106 are suitable decomposition organisms. Such a suitable decomposition organism may be a selected insect such as the Black Soldier fly, although other insects or even bacteria or fungus colonies may be suitable. Typically, the type of decomposition organism may be selected based on the characteristics of the organic substance that is to be processed as well as the geographical location of where the system is placed. As an example, in Southern China, including the Greater Bay Area and surrounding cities, the Black Soldier fly has been a suitable insect for use in the decomposition of food scraps and food waste. This is because the Black Soldier fly is commonly found in this geographical area, whilst the food items that are commonly consumed by people who live in Southern China have specific moisture, fat and fibre content that is suitable for consumption by the Black Soldier fly, in turn, creating a symbiosis in decomposing food scapes and food waste in this region. Furthermore, the Black Soldier fly is not known to be pose any biological threat to the environment locally or acts as a host or vector for disease. Similarly, if the system was to be deployed in other parts of the world, the climate, diet of the local people and the availability of certain types of native insects, bacteria or fungus, may affect the choice of decomposition organism for the system.

As shown in FIG. 1, the system includes a modular frame 103 which comprises multiple layers that can be stacked on top of each other. The frames 103 can have as many layers as desired and typically may include a lower portion 102 and an upper portion 104, separated by a column that may also be modular. Both the upper portion 104 and the lower portion 102 includes shelf space 105 for a plurality of containers 106 that may be stowed within each of the shelf space 105. These containers 106 may initially house a portion of the decomposition organisms within it, such as the Black Soldier fly larvae. Then, once the organic substances are placed within the container (e.g., food waste or organic scraps), the larvae may then mature quickly to start to consume the organic substance. In turn, depending on the decomposition organism, a fertilizer may be created from the decomposition organism. This fertilizer may then be collected for subsequent usage or recycling in agriculture or in industrial applications. Preferably, between the upper portion 104 and the lower portion 102 is a gap 110 between the upper 104 and lower 102 portion. This space is useful as it provides a space 110 for users to temporarily store items whilst preparing to use the system 100 or alternatively, it may also allow users of the system 100 to conduct the organisation, processing or sorting of the organic substances before starting the processing by the system 100. In this example, the gap 110 is positioned around the waist height of a typical user, and thus the lower portion 102 may have more containers 106 then the upper portion 104, although this will depend on the preferred deployment of the system 100 at the specific location based on the surrounding environment and its dimensions. In this gap 110, a workspace may be provided with additional tools to assist in preparing the organic substance for processing, such as the inclusion of one or more shredder units 108 as shown in FIG. 1, which includes manual shredder unit 108 placed on the workspace 110, and whereby a container 106 may be placed directly underneath it such that the shredded organic substances, such as food waste or scraps may be shredded and fall straight into the container 106 below.

Alternatively, other service modules may also be placed in this gap 110, such as, and without limitations, a hand washing unit (not shown), which may include a wash basin and a water fed tap unit for users who desires to wash their hands immediately after handling their organic waste.

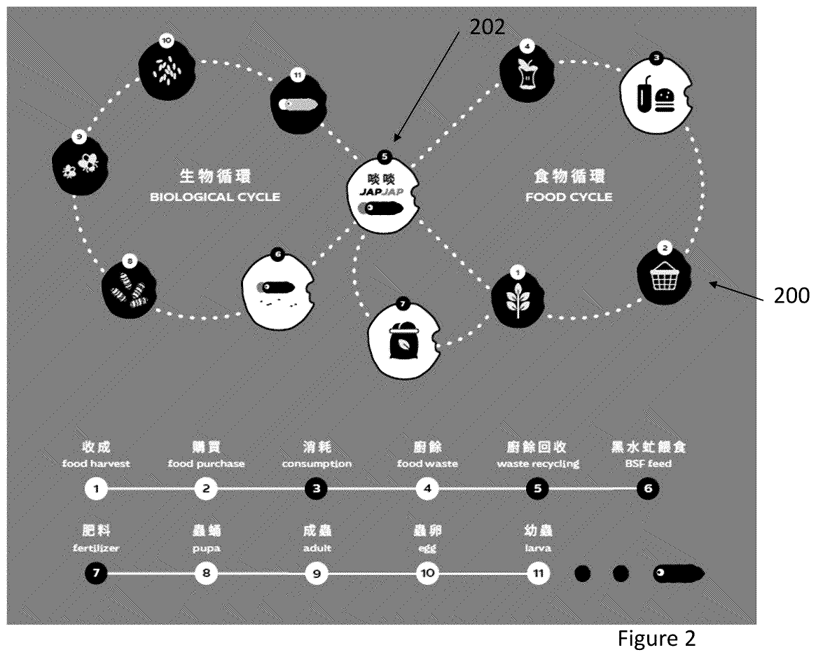

The modular organic substance processing system 100 may be advantageous as it provides a modular unit that allows for organic waste, such as food scraps or food waste, to be processed whilst producing a useful fertilizer. As illustrated in FIG. 2, the processing system is arranged to use a decomposition organism, such as an insect, to process the organic substance by consuming it. This ensures that the insect is able to grow and generate new generations of the insects, whilst simultaneously generate fertilizers that may be useful for domestic or commercial agriculture or industrial applications. Moreover, organic waste, such as food scraps or food waste that would otherwise go to landfill, may also be recycled into a fertilizer, and thus the normal organic processing of food nutrients, e.g., from soil to plant matter to food, may be returned to the soil in the form of fertilizers or the usage of ammonia for energy or other useful industrial uses.

As shown in FIG. 2, the cycle 200 starts at (1) where food is grown with the use of fertilizers (or livestock consumes grown animal feed). The food is then sold (2) to end users who would consume (3) the food, but during the transportation, production and consumption, much waste would be generated (4). At this point, the user may choose to recycle the waste (5) and use the system 100 to recycle the waste by feeding the decomposition organisms (e.g., Black Soldier fly larvae) with the food waste.

At the recycling process (5), the decomposition organisms 202 will then consume the food waste and this process causes the creation of fertilizers from the waste of the decomposition organisms. Additionally, a new generation of the decomposition organisms, in pupa stage (8) will be born to the decomposition organisms which will develop into adults (9) and create new eggs (10) and larvae (11), which will in turn be used to process more food waste (5).

The system 100 is therefore able to provide a biological cycle to the recycling of organic waste and to return byproducts of food or other organic items to the soil in which it originated. The system is also self-sustaining by allowing the decomposition organism to consume the food waste and thus reproduce for subsequent processing of new organic waste.

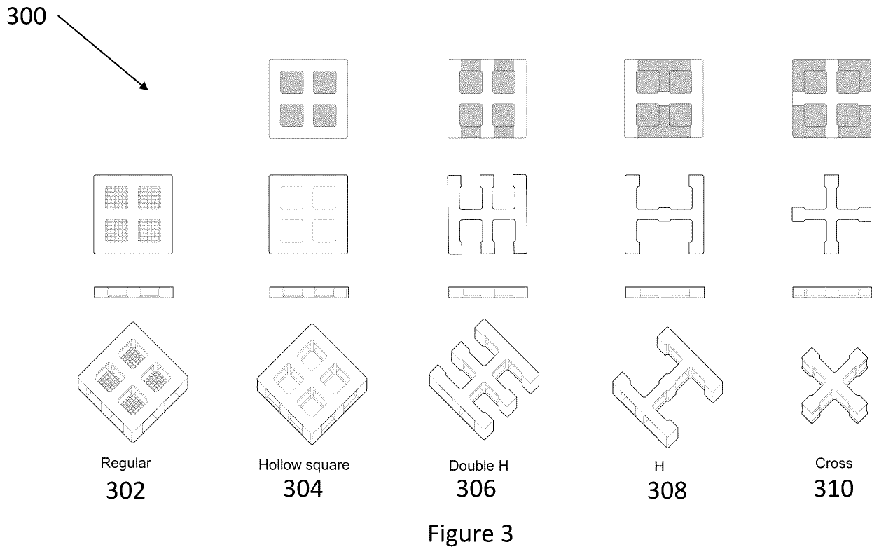

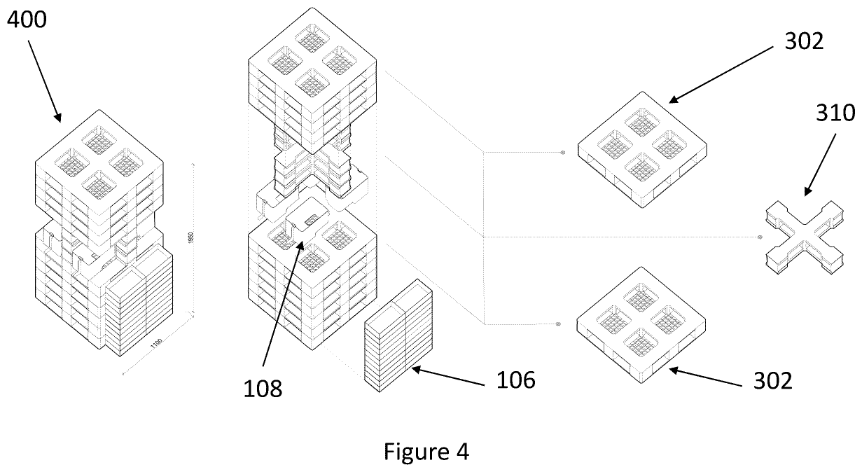

With reference to FIGS. 3 and 4, there is illustrated various structural members 300 that may be used to define the modular frame 103 of the modular organic substance processing system 100. As shown in FIG. 3, these various members 300 may be custom made into these shapes with various materials including wood, plastic or recycled plastics, but preferably, the varies members 300 are components of various pallets or transportation platforms that are commonly used by food supply chains to transport various food items or consumer goods. These pallets are used to support cargo packs comprising of boxes, bags or sacks, which may then be transported by use of forklift trucks onto freight vehicles such as trucks, rail, ship or aircraft.

These pallets may come in various forms but generally comprise of the parts 300 as illustrated in FIG. 3 including regular pallets 302, hollow square pallets 304, double H member 306 as obtained from disassembling or cutting a pallet, H pallet 308 as obtained from disassembling or cutting a pallet and the cross member 310 as obtained from disassembling or cutting a pallet. As illustrated in FIG. 4, these parts may then be used to assemble the modular frame 103 of the modular organic substance processing system 100, including the lower portion 102, upper portion 104 and the support columns in between. Each of these parts may be secured or engaged into position by use of fasteners such as rivets, screws, nails, staples, tape, or glue. As it will be appreciated by a person skilled in the art, the flexibility of the pallet parts could mean that certain parts are stacked, cut or engaged together to form various configurations of the modular frame 103 as desired for its usage or user preference. As an example, where the containers 106 may be of a different size (e.g. taller, wider or deeper), the pallet parts may be cut or removed so as to produce a larger opening for the larger containers 106 to be stowed within.

Moreover, due to the modular nature of the modular frame 103, the modular organic substance processing system 100 may be adapted to different configurations to suit specific needs. For example, where the system 100 will be placed in a low ceiling warehouse, the modular frame 103 may be adapted to have a shorter upper portion 104. In another example, should the system 100 be adapted for use in schools by children, then the lower portion 102 may be stacked with the various members 300 to be of a lower height to accommodate for accessibility by the children. In some examples, the system 100 may be deployed for use in a garbage disposal room or within a waste processing area of a food processing facility, and thus the system 100 may be implemented with the pallet members as desired for the specific area or usage.

The use of the various members 300 as shown in FIGS. 3 and 4 adds an additional advantage to the system 100 by making use of pallets that are already commonly in use. Moreover, such pallets are often disposed of by supply chain, transport or retail companies and such retired or damaged pallets are often directed to landfill. In turn, by designing an example of the system 100 to have a modular frame 103 constructed with the use of these pallet members 300 would in turn allow for the system 100 to be built with low cost whilst also reusing old pallet members that may otherwise be destined for landfill, and thus reducing the burden on landfills.

With reference to FIG. 5, there is illustrated an alternative embodiment of the modular organic substance processing system 500. In this embodiment, the system 500 includes one or more sensors 502 to sense the environmental conditions of the system 500 as well as the conditions of each of the containers 106. The environment data as obtained from these sensors 502 may in turn be processed by an electronic system, computer, server, edge device, computing system and/or transmitted via a communication interface over a communication network 504 to a cloud server 506 and to individual users who may then be able to review and monitor the status of the system in processing their food waste or scraps on their personal devices such as smartphones 508, IoT devices or computers 510.

As mentioned earlier, since each container 106 may have decomposition organisms, such as insects, the condition of the container 106 may affect the wellbeing of the organisms. Accordingly, the sensors 502 placed on the system 500 may include environmental sensors such as temperature 502t, humidity 502h, chemical sensors (to detect for various chemical compounds, including ammonia), infra-red heat sensors, and may be placed both the areas around the system 500, as well as within each container 106 itself.

The measurement of the temperature 502t and humidity 502h is particularly useful in these embodiments as the efficiency and wellbeing of certain insects, such as the Black Soldier fly larvae has an optimal range. As the environment of where the system 500 is placed as well as the food scraps that are being processed by the insects may change, the continuous monitoring of the temperature and humidity is particularly useful in determining the wellbeing of the insects as well as the stage in which the food waste has been processed.

In another example, cameras 502c may also be placed around the modular frame 103 itself so as to capture the contents and activities of each container 106. This is particularly helpful as users can remotely see the decomposition organism in processing their food waste as well as the wellbeing of any decomposition organism itself. This is particularly advantageous when the system 500 is used by children or students as they are able to experience the recycling process as well as the growth of the decomposition organism in real time by viewing the video streams of each of the containers 106.

In another example embodiment, the system 500 may further include a weighting scale around each container 106 so as to measure the mass of each container in real time. This may be implemented using a weight sensor placed on the support of each container 106 and proceed to measure the weight of the container in real time. This is particularly helpful as the weight of the container could indicate the amount of food waste which has been consumed by the decomposition organism, and thus where the weight has been reduced to below a particular threshold from when the food waste was first filled, the container 106 may then be suitable to receive more food waste.

In this example, the weighting sensor may continuously measure the weight of each container and in turn, the weight or the difference of the weight over a period of time may operate an indicator to show which container is suitable to receive more food waste. This is particularly advantageous in situations where all containers 106 are already in use, but as some containers 106 are capable of receiving more food waste due to the difference in consumption rate by the decomposition organisms, users can distribute their food waste to these containers 106 which are not yet full, with a centralised computing or electronic system being arranged to control which of the containers 106 may receive more food waste by showing indicators to users.

In another example embodiment, the system 500 is further arranged to be active in controlling the environment of each container 106. By measuring the temperature and the humidity, should the temperature or humidity exceed or fall below a particular threshold, the system 500 may be controlled to operate fans to cool down the containers 106. A moisture delivery system, such as a misting gun, may also be operated for a controlled period of time to increase the humidity of the containers 106. Similarly, where the humidity exceeds a threshold, the system may direct users to add more dry food waste to certain containers, or alternatively, previously dried food waste or organic materials such as dry food scraps, including oats, bread, biscuits or other forms of dry or moisture absorbing food scraps, may be added to containers in which humidity has exceeded the threshold.

Preferably, the addition of these dry food scraps would be performed automatically and controlled by the system 500 itself. A store of these dry food scraps may be accessed and then mechanically disposed onto each container as required based on the moisture level detected. A mechanical stirring device may also be placed in, near or adjacent to each container so as to gently stir the dry food scraps into the existing food scraps to reduce the overall moisture content of the food scraps being processed.

As illustrated in these examples of a modular organic substance processing system 100, 500. It is expected that each modular system may be created with retired pallets and placed in a stable environment such as a shaded part of a garden, workshop, warehouse or open space. Once placed in these environments, users, including recycling adults, children or students, may then bring along their food waste from home, school or work. Such food waste may include left over or spoilt meats, vegetables or fruits, and may be cooked, seasoned or raw.

Once the user brings their food waste, the user may firstly shred their food waste using one of the shredders so as to reduce the size of individual pieces of the food waste. The user may place their food waste into the shredder and then proceed to find a free container which does not already have food waste or filled with food waste for processing. These free containers or containers which have more capacity may be marked electronically with an LED indicator and thus making it easier for the user to identify a free container.

Once the user has found a free container, the user may then place the container in a shelf below the shredder and proceed to shred their food waste into the container. A user will be given guidance on how much waste should be placed within each container dependent on the size of the container and the expected time in which the food waste is expected to be processed. Where a weighing scale is placed within the system 500, guidance can also be provided to the user as to how much food waste should be added. Once the user places the correct amount of food waste within the container, the user may then place it within an empty shelf. A code on the empty shelf or an RFID circuit marking each shelf would allow the user to quickly find a free shelf to place their container of food waste for processing.

Once the food waste is placed within each shelf, the user may leave and allow the food waste to be processed by the decomposition organism. In one example where the system is used in Southern China, the food waste may be processed by the Black Soldier fly larvae which would begin to eat the food waste. Once fed, and overtime, the Black Soldier fly larvae may grow to be adult flies which may in turn also reproduce thereby producing a new generation of Black Soldier fly larvae for restocking into a container. Preferably, once the Black Soldier fly larvae is observed or detected to be maturing into adults, it is removed from the container and placed elsewhere, such as an incubation area, space or breeding chamber to live its life whilst reproducing new fly larvae. These new fly larvae may then be collected and used for restocking into the containers so as to consume new food waste.

During this time whereby the food waste is consumed by the Black Soldier fly larvae, the environmental sensors as well as cameras will continue to monitor the conditions of the container. If the environmental sensors indicate that the temperature or humidity has exceeded or fallen below a specific threshold (e.g. below 30% or over 70%, which is beyond the optimal range for Black Soldier fly larvae), then an alert may be raised to the user or support crew to inspect the container and to resolve any issues by cleaning the container and replacing it with a new population of decomposition organisms, or an automated control system as described above, may be used in an attempt to control the temperature or humidity of the system.

In turn, the sensor data or video streams may be transmitted to a cloud server whereby users may access this data via a web interface or app on their smart devices. Users interested in the recycling process may find it interesting to review the progress of their waste processing. Furthermore, information relating to each recycling process may also be stored or process for gamification or rewards, which would make the entire recycling process more interesting and rewarding for the end user. This is advantageous as gamification, rewards or competition may encourage users to be more active in the recycling process and to encourage other users to join the recycling community.

After the food waste has been processed, the decomposition organism should produce Nitrogen or Ammonia rich materials such as fertilizers. These fertilizers may also be collected by a user or support crew for further processing or reuse. The fertilizers collected may also be weighted and be awarded to the user for use in their own hobbies, or it may be given or sold to chemical industries. The generation of the fertilizers may also be part of the rewards or gamification to encourage more users in participating in the recycling process.

In another example, the system 100 may also be used as part of a food processing process that may be implemented in a garage processing room, agricultural production line, commercial kitchen or commercial food processing facility such as those that are located in hotels, factories or restaurants. In these settings, food waste or kitchen waste may be generated as part of the general food preparation process, or may be generated as part of the processing of agricultural or fishery products such as mills, canneries (the caning of food items), breweries (the production of beverages) or vineyards in the preparation of food or beverage items.

In these examples, the system 100 may be adapted to be part of the food processing chain, whereby food or kitchen waste produced as part of the food processing chain may be delivered, inputted or fed directly to the system 100 for decomposition. Preferably, as the food or kitchen waste can vary in characteristics, including moisture, texture or composition, an additional sorting or processing steps such as drying may be added before it may be processed by the system 100.

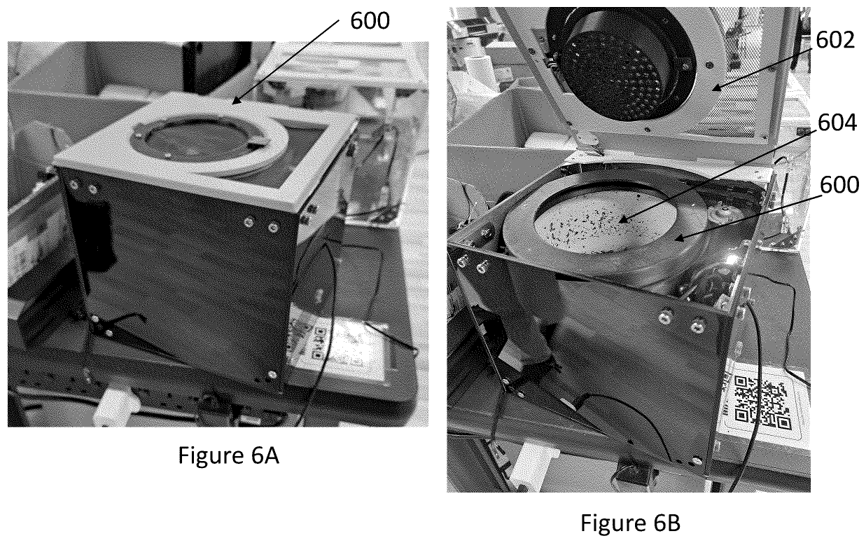

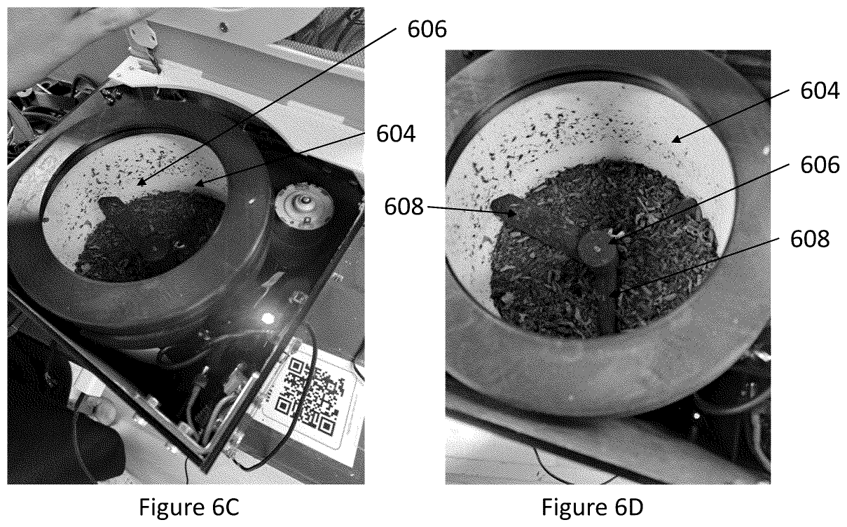

With reference to FIGS. 6A to 6D, there is illustrated an embodiment of an alternative example of a container 106 as shown in FIG. 1. In this example embodiment, the container 600 is a “smart” or “enhanced” version of the container 106 shown in FIG. 1, for containing the food waste that are to be processed by the decomposition organism. In this example embodiment, the smart container 600 is also arranged to contain the food waste for processing by the decomposition organism, including the Black Solider fly larvae or any other similar or suitable organism. However, so as to improve the efficiency of the processing of the food waste, the smart container 600 includes a mixer module arranged manipulate the food waste with the decomposition organism so as to increase the access of the organism to the food waste, and thereby, increase the efficiency of the processing of the food waste by the decomposition organism. Additionally, the smart container 600 also includes a sensor module which may be used to monitor the environment of the container 600, including the humidity or temperature of the contents of the container 600, and in turn allow a controller to take the appropriate action, such as by operating a fan to cool the container, a heater to heat the container, or the inclusion of water or dried food waste to increase or decrease the humidity of the container. The sensor module may also include a chemical sensor which may be arranged to detect for various chemical compounds, including formaldehyde, Volatile Organic Compounds (VOCs) or ammonia, etc). The detection of ammonia is also helpful as it can determine the rate of the food waste in being processed by the decomposition organisms and trigger specific actions or alerts.

As shown in FIG. 6A, the smart container 600 may be arranged to be placed within the shelf members 105 of the modular frame 103 of the food processing system 100. Depending on the size of the smart container 600 and the shelf members 105, one or a plurality of smart containers 600 may be stowed within each shelf member 105. When upon a user wishes to use the smart container 600 to process food waste, a container 600 may be removed from the shelf member 105, with the user opening the lid 602 of the container 600 as shown in FIG. 6B. Once the lid is opened, the container chamber 604 is revealed, as shown in FIG. 6C and FIG. 6D.

The chamber 604 is arranged to receive the food waste as well as the decomposition organism (e.g. Black Soldier fly larvae, or any other suitable insect or organism). Preferably, the chamber 604 should only receive a suitable amount of food waste and larvae so as to be optimized for the food waste to be processed, as too much of each would put the processing of the food waste to be out of balance. Once the food waste has been processed, the processed food waste may be saved for other uses, such as fertilizers or processed oils, fats or proteins, which may in turn be used for other commercial or industrial uses.

In this example embodiment as shown in FIGS. 6C and 6D, the chamber 604 also has a manipulation tool, which is in the form of a mixer module 606. The mixer module 606 includes a manipulation arm 608, which includes a plurality of arms extending away from a rotating axis to move the food waste and the decomposition organism. The arms are arranged to slowly disturb the food waste substrate slowly, so as to move, shift or otherwise manipulate the food waste substrate slowly, without causing injury to the larvae. Such speeds may be, for example, one revolution every 5 minutes, 10 minutes, 20 minutes, 30 minutes or even one hour.

The function of the mixer module 606 is particularly advantageous as disturbing the food waste substrate would allow the larvae to be mixed within the substrate, and thereby increasing the access of the food waste to the larvae. In turn, this may result in a more efficient processing of the food waste by the larvae and could increase the efficiency of the food processing system in processing food waste.

Although not shown, the smart container 600 includes a plurality of sensor units to measure the humidity and temperature of the food waste substrate. Since the food waste received from the user may be of varying quality, substance and moisture, the sensors would be able to correct any variations of the humidity or temperature so as to ensure both variables are optimal or more optimal for the organisms to process the food waste. For example, the mixer module 606 may be arranged to assist with mixing in dry food waste items, such as “bread or biscuit crumbs” to reduce the moisture of the food waste substrate. Alternatively, if the moisture is to be increased, water may be added to the food waste substrate and mixed with the mixer module to increase the moisture.

Preferably, when the smart container 600 detects that the humidity and temperature of the food waste substrate (a combination of the organic substance (the food waste) and the decomposition organism (Black Soldier Fly Larvae, for example)), in addition to the addition of heat (by heater) or ventilation (cooling by fan) or the addition of dry organic substances such as bread or biscuit crumbs or water to increase the moisture, the controller unit may also be directed to increase the speed of the motor unit to speed up the manipulation or disturbing of the food waste substrate. This is particular advantageous as the temperature or humidity adjustment may be made more quickly and evening within the substrate so as to maintain the efficiency of the food processing system in conditions which would be less optimal.

The smart container 600 will preferably have a controller circuit which would include a microprocessor and a communication gateway to take readings from the sensors, as well as to control the mixer module 606. Additionally, the microprocessor may use the communication gateway to communicate information to a cloud based service or server, or to a user's personal device (e.g. smartphone or IoT Device) to communicate the status of the container 600 and its food waste substrate. Alerts or alarms, as well as processing time may be stored or transmitted to a user or manager to monitor the progress of the food waste processing, and in turn, may trigger an attendant to empty out the food waste and restock it with new larvae or new food waste.

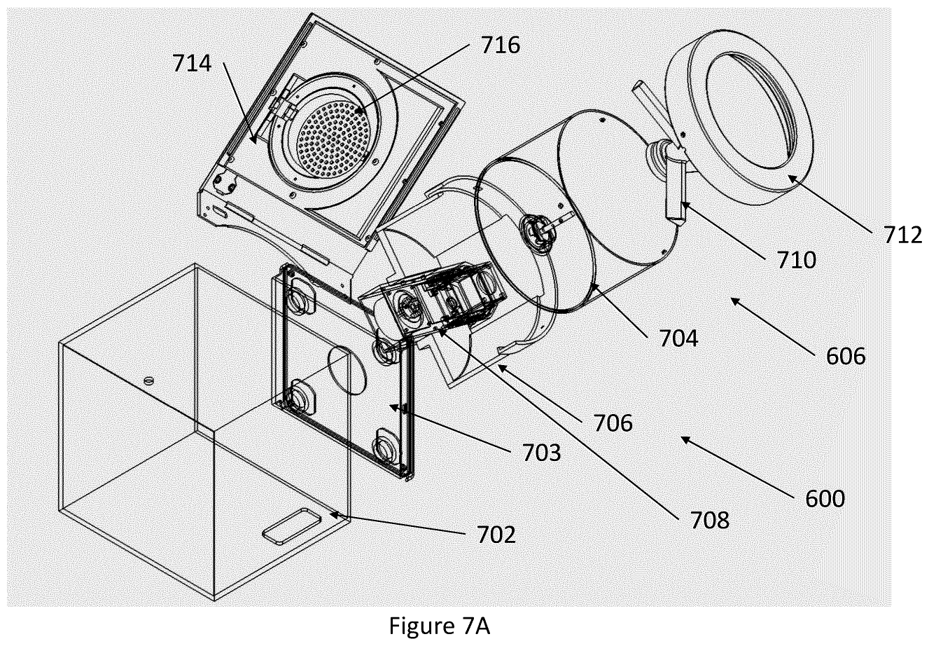

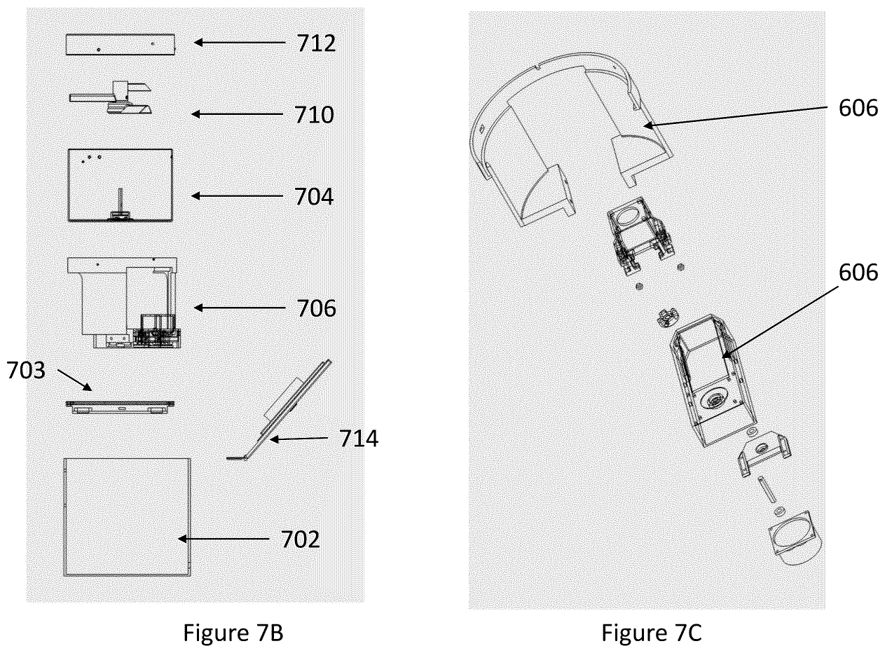

With reference to FIG. 7A to 7C, there is illustrated exploded diagrams of an example of the smart container 600. As shown, the smart container 600 includes an outer housing 702 arranged to house the container and its arrangement, and its preferably made from a resilient and lightweight material such as ABS plastics. Additionally, a supporting based plate is placed within the housing to support the mixer module 606, which itself includes a container body 704, a support cylinder 706 to support the container body 704, and a motor housing 708, which houses the motor that is arranged to drive the manipulation arm 710. This arrangement is advantageous as the container body 704 can be removed from the housing for service, such as cleaning or the repair of electrical components of the smart container 600.

Finally, a top ring 712 is placed on the lip of the container body 704 to protect the edges of the container body 704, and to prevent food waste from being placed, accidently, into other parts of the smart container 600. Preferably, the top ring 712 has an annular lip portion which extends to cover the container body 704 to aid in the prevention of the decomposition organisms from exiting the container body 704. In examples where the decomposition organisms are Black Soldier Fly Larvae, the larvae may attempt to climb up the walls of the container body 704, but would unlikely be successful in leaving the container body 704 as it would be prevented from exiting the body due to the presence of the top ring 712, whereby the lip of the top ring 712 will see that the larvae have to climb upside down for some distance in order to exist pass the top ring 712. Additional spaces between the container body 704 and the housing 702 itself may be suitable for the storing of control circuits, communication gateways and batteries to power the smart container 600.

The smart container 600 also includes a door 714, which is arranged to be hinged onto the edge of the housing, with the door 714 having a annular vent opening 716 that may be opened to access the container body 704. This is particularly advantageous as the door 714 may not needed be accessed unless maintenance is required on the smart container 600. The user may simply use the vent 716 opening to place and food waste. As shown in this example, the vent 716 opening also includes a plurality of apertures so as to ensure there is sufficient ventilation and fresh air into the container body 704.

Although not required, the embodiments described with reference to the Figures can be implemented as an application programming interface (API) or as a series of libraries for use by a developer or can be included within another software application, such as a terminal or personal computer operating system or a portable computing device operating system. Generally, as program modules include routines, programs, objects, components and data files assisting in the performance of particular functions, the skilled person will understand that the functionality of the software application may be distributed across a number of routines, objects or components to achieve the same functionality desired herein.

It will also be appreciated that where the methods and systems of the present invention are either wholly implemented by computing system or partly implemented by computing systems then any appropriate computing system architecture may be utilised. This will include stand-alone computers, network computers and dedicated hardware devices. Where the terms “computing system” and “computing device” are used, these terms are intended to cover any appropriate arrangement of computer hardware capable of implementing the function described.

It will be appreciated by persons skilled in the art that numerous variations and/or modifications may be made to the invention as shown in the specific embodiments without departing from the spirit or scope of the invention as broadly described. The present embodiments are, therefore, to be considered in all respects as illustrative and not restrictive.

Any reference to prior art contained herein is not to be taken as an admission that the information is common general knowledge, unless otherwise indicated.

1. A modular organic substance processing system comprising:
a modular frame arranged to support a plurality of containers, each container housing a plurality of decomposition organisms arranged to aid in the decomposition of organic substance, wherein the modular frame includes a plurality of shelf members, each shelf member being arranged to be stackable on another shelf member to define the modular frame.

2. A modular organic substance processing system in accordance with claim 1, wherein the system further comprises a shredder unit arranged to shred the organic substance and to deposit the shredded organic substance into one of the plurality of containers.

3. A modular organic substance processing system in accordance with claim 2, wherein the modular frame includes a separation column to separate the plurality of shelf members into an upper portion and a lower portion, each portion arranged to house a plurality of containers.

4. A modular organic substance processing system in accordance with claim 3, wherein the separation column creates a gap for the shredder unit to be disposed therein.

5. A modular organic substance processing system in accordance with claim 4, wherein the organic substance includes food waste items.

6. A modular organic substance processing system in accordance with claim 5, wherein the decomposition organisms include insects.

7. A modular organic substance processing system in accordance with claim 6, wherein the insects are Black Soldier fly larvae.

8. A modular organic substance processing system in accordance with claim 1, wherein the containers include one or more environmental sensors arranged to detect the environment data representative of the conditions of each of the containers, and the one or more environmental sensors are arranged to communicate with a communication gateway to transmit the environmental data to one or more users.

9. A modular organic substance processing system in accordance with claim 9, wherein the environmental sensors include a temperature sensor, humidity sensor, weight sensor, chemical sensor, or any one or combination thereof.

10. A modular organic substance processing system in accordance with claim 1, wherein the plurality of shelf members are reused pallet members.

11. A modular organic substance processing system in accordance with claim 1, wherein the container includes a mixer module arranged to manipulate the plurality of decomposition organisms and the organic substance.

12. A modular organic substance processing system in accordance with claim 11, wherein the mixer module includes one or more manipulation arms arranged to be driven by a motor unit to manipulate the plurality of decomposition organisms and the organic substance.

13. A modular organic substance processing system in accordance with claim 12, wherein the one or more manipulation arms are arranged to extend away from a central rotational axis, the axis being driven by a motor to move the one or more manipulation arms within a container body containing the decomposition organisms and the organic substance.

14. A modular organic substance processing system in accordance with claim 13, wherein the one or more manipulation arms are moved slowly within the container body.

15. A modular organic substance processing system in accordance with claim 14, wherein the container is further arranged to receive dry organic material or water to adjust the humidity of the decomposition organisms and the organic substance.

16. A modular organic substance processing system in accordance with claim 15, wherein the one or more manipulation arms are moved with varying speed to adjust the humidity of the decomposition organisms and the organic substance.

17. An enhanced container for a modular organic substance processing system comprising:
a container body arranged to receive a mixture of decomposition organisms and organic substance;
a mixer module arranged to manipulate the mixture of decomposition organism and organic substance; and,
a controller unit arranged to automatically control the mixer module to adjust the manipulation of the mixture of decomposition organism and organic substance.

18. An enhanced container for a modular organic substance processing system in accordance with claim 17, further comprising:
a sensor module arranged to measure the humidity and temperature of the mixture of decomposition organisms and organic substance, and;
wherein the sensor module is further arranged to include a chemical sensor arranged to measure the ammonia content of the mixture of decomposition organisms and organic substance.

19. An enhanced container for a modular organic substance processing system in accordance with claim 18, wherein the humidity and temperature of the mixture of decomposition organisms and organic substances triggers a humidity or temperature adjustment response, which includes: the addition of dry organic substance or water to adjust the humidity of the mixture; or the application of heat or air flow to adjust the temperature of the mixture; and the speed of the manipulation of the mixture of decomposition organism and organic substance.

20. An enhanced container for a modular organic substance processing system in accordance with claim 19, wherein the container includes an access door with a vent aperture, wherein the vent aperture is arranged to access the contents of the container body and the access door is arranged to access the container body, mixer module, the controller unit and the sensor module.

21. A food processing component for use as part of a food production chain comprising: a modular frame arranged to support a plurality of containers, each container housing a plurality of decomposition organisms arranged to aid in the decomposition of organic substance, wherein the modular frame includes a plurality of shelf members, each shelf member being arranged to be stackable on another shelf member to define the modular frame.

22. A food processing component in accordance with claim 21, wherein the plurality of containers includes one or more enhanced containers for a modular organic substance processing system comprising:
a container body arranged to receive a mixture of decomposition organisms and organic substance;
a mixer module arranged to manipulate the mixture of decomposition organism and organic substance;
a controller unit arranged to automatically control the mixer module to adjust the manipulation of the mixture of decomposition organism and organic substance; and,
Wherein the one or more enhanced containers are supported by adapting the size of the shelf members.

23. A food processing component is accordance with claim 22, further comprising:
a sensor module arranged to measure the humidity and temperature of the mixture of decomposition organisms and organic substance, and;
wherein the sensor module is further arranged to include a chemical sensor arranged to measure the ammonia content of the mixture of decomposition organisms and organic substance.

24. A food processing component is accordance with claim 23, wherein the humidity and temperature of the mixture of decomposition organisms and organic substances triggers a humidity or temperature adjustment response, which includes: the addition of dry organic substance or water to adjust the humidity of the mixture; or the application of heat or air flow to adjust the temperature of the mixture; and the speed of the manipulation of the mixture of decomposition organism and organic substance.

25. A food processing component in accordance with claim 24, wherein the container includes an access door with a vent aperture, wherein the vent aperture is arranged to access the contents of the container body and the access door is arranged to access the container body, mixer module, the controller unit and the sensor module.
